(19) United States
(12) Patent Application Publication
(10) Pub. No.: US 2012/0048511 A1
(43) Pub. Date: Mar. 1, 2012

(54) Spiral-path chimney-effect heat sink

(75) Inventor: Vahid S. Moshtagh, San Jose, CA (US)

(73) Assignee: Bridgelux, Inc.

(21) Appl. No.: 12/807,272

(22) Filed: Aug. 31, 2010

(51) Int. Cl. F28F 13/00; B23P 15/26; F28F 1/00

(52) U.S. Cl. 165/80.2; 165/177; 29/890.053

(57) ABSTRACT

A spiral-path chimney-effect heat sink cools an LED light bulb by increasing the length of the path over which heated air rises between two coaxial tubes. A tube top is attached to one end of the tubes. A light emitting diode (LED) is thermally coupled through the tube top to the inner tube. There are window openings below the rim where the outer tube attaches to the tube top. A convection current path guide is disposed between the inner and outer tubes. The convection current path guide is a spiral wire that causes rising air to follow a longer spiral path around the heated inner tube before the air exits the heat sink through the window openings. An Edison screw base is attached to the end of the inner tube opposite the end attached to the tube top. The coaxial tubes can be cylindrical tubes, conical tubes or square tubes.

### TECHNICAL FIELD

The present invention relates generally to heat sinks and, more specifically, to improving the performance of a chimney-effect heat sink.

### BACKGROUND INFORMATION

The demand for ever more efficient sources of light has led to a progression from incandescent lights to specialized fluorescent lights, e.g., using sodium or mercury vapor, to light emitting diodes. Light emitting diodes (LEDs) not only exhibit relatively high efficiency, but also offer a relatively uncomplicated construction and a long useful life. LEDs do, however, emit relatively large amounts of heat and require suitable heat sinks to dissipate that heat. An efficient heat sink can extend the lifespan of an LED light by preventing the LED from operating at excessively high temperatures. Heat sinks for LED lights have been fabricated by extruding them from aluminum or an aluminum alloy. The extrusion process involves pushing the heat-sink material through a die of the desired cross-section.

FIG. 1 (prior art) shows a cross section of an exemplary extruded heat sink 10 that is used to cool an LED light. One limitation of making a heat sink using an extrusion process is that a hollow area in the interior of the extruded product cannot be formed without machining the heat sink after the material has been extruded. The heat sink of FIG. 1 is formed by combining two extruded pieces (upper and lower pieces in FIG. 1) to avoid having to machine the interior area. In order to take advantage of the “chimney effect,” wings 11 are added to the ends of the fins 12. The wings 11 keeps the heated air together in the chimney-like ducts 13 and cause the rising heated air to pull up air beneath it in a convection process. The chimney-like ducts 13 are not, however, sealed off tubes because the extrusion process does not permit hollow areas. Consequently, only a partial chimney effect is achievable.

FIG. 2A (prior art) shows a second extruded heat sink 14 used with an LED light. U.S. Patent Application Publication 2009/0296387 discloses that an outer cylindrical wall 15 and fins 16 are formed from an extrusion process. FIG. 2B (prior art) shows that the inner cylinder is formed by another process and is not part of extruded heat sink 14. Fully enclosed ducts 17, however, are formed between heat sink 14 and an internal housing 18.

One factor that affects the performance of a heat sink is the distance over which air rises along the heated surfaces of the heat sink. More heat is transferred from the heated surfaces to the air if rising air travels for a greater distance over the heated surfaces.

FIG. 3 (prior art) shows a third extruded heat sink 19 used with an LED light. Extruded heat sink 19 has fins 20 with a slight wave. Although the wave in the fins appears to be added for aesthetic purposes, heated air rising between the wavy fins 20 does travel a greater distance over the fins than if the fins were planar. The added surface area and distance traveled by the rising air, however, is not significantly greater than if the fins were planar.

A heat sink is sought that allows rising heated air to travel a greater distance over the surfaces of the heat sink than the air would travel along planar fins, while at the same time benefiting from the convection in enclosed ducts that results from the chimney effect.

### SUMMARY

A chimney-effect heat sink is used to dissipate heat generated by a light emitting diode (LED) of an LED light bulb. The heat sink includes an outer tubular portion, an inner tubular portion and a guide disposed between the inner tubular portion and the outer tubular portion. The inner tubular portion is disposed inside the outer tubular portion such that the inner and outer tubular portions are coaxial. The guide forms a convection current path between the inner tubular portion and the outer tubular portion. The outer surface of the inner tubular portion has a length in the dimension parallel to the axes of the tubular portions. The convection current path formed by the guide is longer than the length of the outer surface of the inner tubular portion.

Another embodiment of the chimney-effect heat sink has an outer tube, an inner tube, a tube top and a convection current path guide. The inner tube is disposed inside the outer tube such that the inner tube and the outer tube are coaxial. The coaxial tubes can be cylindrical tubes, conical tubes or square tubes. The tube top is disposed at one end of the inner tube and is thermally coupled to the inner tube. The tube top is shaped as a disk that extends in a plane perpendicular to a central axis of the inner tube. The convection current path guide is disposed between the inner tube and the outer tube and has a spiral structure. The convection current path guide causes a convection current to follow a spiral path around the outer surface of the inner tube. In one aspect, the tube top and the inner tube are integrally formed such that the end of the inner tube is capped.

Yet another embodiment includes an inner tube with a first central axis, an outer tube with a second central axis, a convection current guide, and a tube top that is thermally coupled to the inner tube and is disposed at a first end of the inner tube. A heat source is attached to the tube top. Window openings are disposed at the first end of the outer tube adjacent to the tube top. The convection current guide has a third central axis. The convection current guide is disposed between the inner tube and the outer tube, and all of the first central axis, the second central axis and the third central axis are collinear. In one aspect, the convection current guide is a spiral wire, and the heat source is a light emitting diode (LED). The inner tube has an outer surface with a length aligned with the first central axis. The convection current guide is longer than the length of the outer surface of the inner tube. An Edison screw base is attached to the second end of the inner tube.

Yet another embodiment includes an inner tube, an outer tube, a tube top and means for increasing the length of the path over which the heated air rises between the inner and outer tubes. The tube top is disposed at one end of the inner tube and is adapted to be coupled to a heat source. The inner tube is disposed inside the outer tube. Air heated by the inner tube rises along a path between the inner tube and the outer tube along the path formed by the means. In one aspect, the means is a spiral wire. In another aspect, the means are spiral fins integrally formed with the outer tube.

A method of manufacturing a chimney-effect heat sink includes making an inner tube and an outer tube from aluminum or an aluminum alloy. The inside surface of the inner tube is coated with a dielectric liner. A convection current guide is placed around the inner tube. The convection current guide is longer than a length of the outer surface of the inner tube that is parallel to the central axis of the inner tube. Then the outer tube is placed over the convection current guide such that the central axes of the inner and outer tubes are collinear. A tube top is then attached to the first end of the inner tube, and an Edison screw base is attached to the second end of the inner tube.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (prior art) is a cross-sectional view of a first type of extruded heat sink with outward facing fins.

FIG. 2A (prior art) is a perspective view of a second type of extruded heat sink with inward-facing fins used in an LED light.

FIG. 2B (prior art) is a cross sectional view of the heat sink of FIG. 2A.

FIG. 3 (prior art) is a perspective view of a third type of extruded heat sink with wavy fins used in an LED light.

FIG. 4 is a cross sectional view of an LED light bulb with a spiral-path chimney-effect heat sink.

FIG. 5 is a more detailed bottom perspective view of the spiral-path chimney-effect heat sink of FIG. 4.

FIGS. 6A-6D are perspective views showing the individual components of the spiral-path chimney-effect heat sink of FIG. 4.

FIG. 7 is an exploded view of the spiral-path chimney-effect heat sink of FIG. 4.

FIG. 8 is a flowchart of steps of a method of manufacturing the spiral-path chimney-effect heat sink of FIG. 4.

FIGS. 9A-9E are perspective views of alternative configurations of the tubes of the heat sink of FIG. 4.

FIG. 9F is a perspective view of a convection current guide that travels in a zigzag path up the surface of a cylindrical inner tube.

FIG. 10A is a cross-sectional view of an embodiment of a spiral-path chimney-effect heat sink with spiral fins.

FIG. 10B is a perspective view of the outer tube of the heat sink of FIG. 10A.

FIG. 10C shows an LED light bulb made using the spiral-path chimney-effect heat sink of FIG. 10A.

FIG. 11 shows another embodiment of a spiral-path chimney-effect heat sink in an LED light bulb.

FIG. 12 is an exploded view of the LED light bulb of FIG. 11.

FIG. 13 is a cross sectional view of the LED light bulb of FIG. 11.

FIG. 14 shows yet another embodiment of an LED light bulb with a spiral-path chimney-effect heat sink with spiral fins.

FIG. 15 is an exploded view of the LED light bulb of FIG. 14.

FIG. 16 is a cross sectional view of the LED light bulb of FIG. 14.

FIGS. 17A-17C show enlarged cross sections of the spiral fins of various embodiments the spiral-path chimney-effect heat sink of FIG. 14.

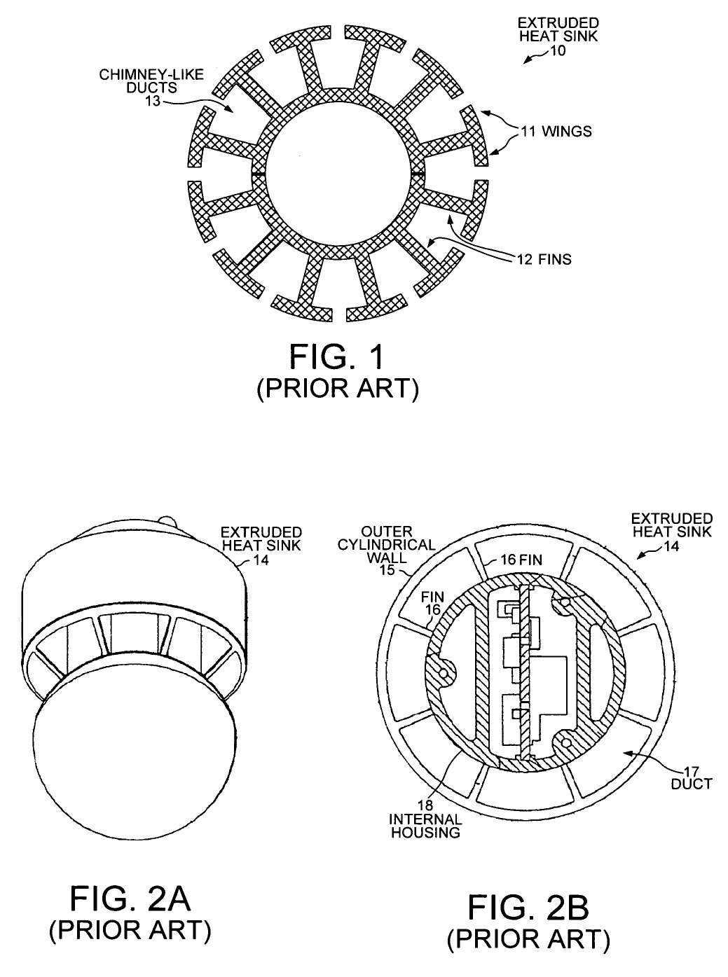

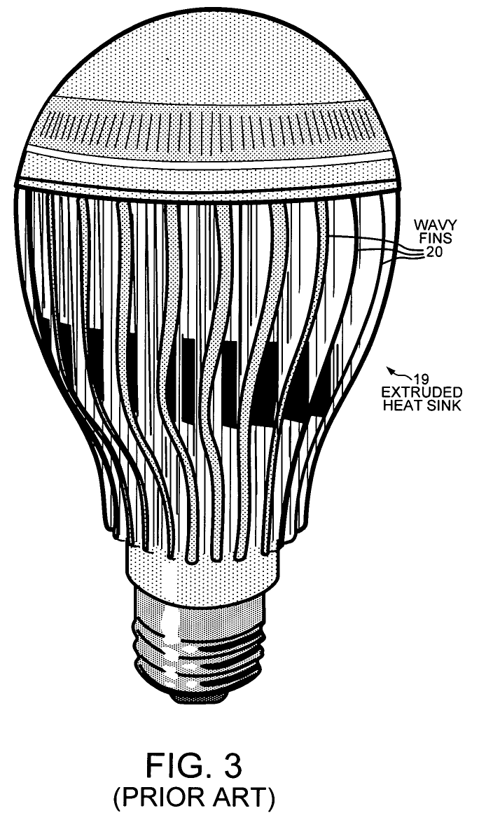

### DETAILED DESCRIPTION

Reference will now be made in detail to some embodiments of the invention, examples of which are illustrated in the accompanying drawings.

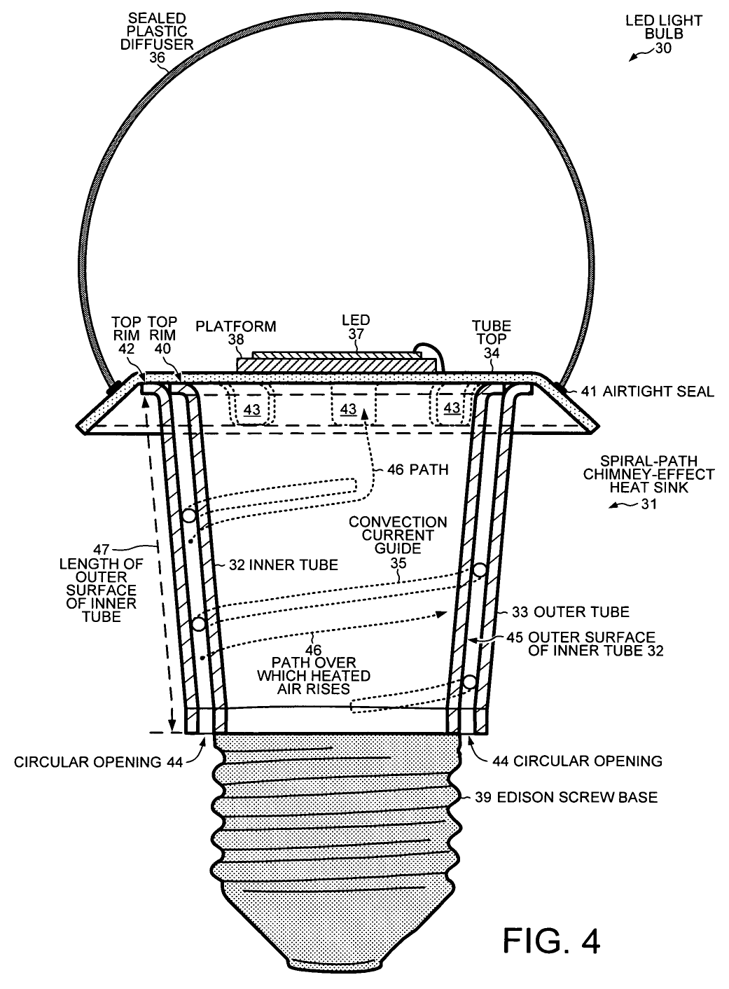

FIG. 4 is a cross sectional diagram of an LED light bulb 30 with a spiral-path chimney-effect heat sink 31. Heat sink 31 has an inner tube 32, an outer tube 33, a tube top 34 and a convection current guide 35. Inner tube 32 and outer tube 33 are coaxial, and convection current guide 35 is disposed between inner tube 32 and outer tube 33. LED light bulb 30 has the form factor of a conventional incandescent bulb. Even through no vacuum is maintained around a glowing filament, a sealed plastic diffuser 36 has the shape of a bulb and is attached to tube top 34. Instead of maintaining a vacuum, sealed plastic diffuser 36 performs the function of diffusing the light emitted from a light emitting diode (LED) 37 that is attached on top of tube top 34. LED 37 is attached to tube top 34 via a platform 38. In one embodiment, platform 38 is made of soft aluminum that is attached to LED 37 via a dielectric layer. In another embodiment, platform 38 is thermally conductive, yet electrically nonconductive. For example, platform 38 can be made of aluminum oxide (Al₂O₃) or aluminum nitride (AlN). An Edison screw base 39 is connected to heat sink 31 on the opposite side of LED 37. Edison screw base 39 is a connector that screws into a conventional light bulb socket.

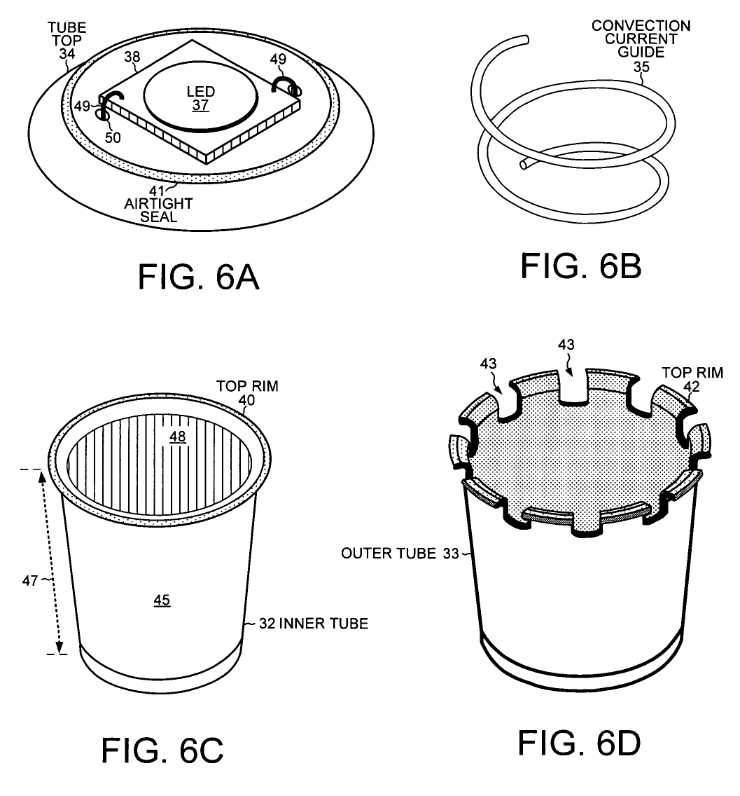

Inner tube 32 is a conical tube whose larger end is attached and thermally coupled to tube top 34. An airtight seal is formed between a top rim 40 of inner tube 32 and the bottom surface of tube top 34. (See FIG. 6C for another perspective of top rim 40.) In one embodiment, top rim 40 is attached to tube top 34 by aluminum welding, soldering or brazing. For example, nickel can be used as a solder between top rim 40 and the bottom surface of tube top 34 and forms a bond between the aluminum surfaces by diffusing into both surfaces. In another embodiment, top rim 40 is attached to tube top 34 using thermal glue. In addition, an airtight seal 41 is formed between sealed plastic diffuser 36 and tube top 34. Thermal glue is also used to make the seal 41. An airtight seal is also formed between inner tube 32 and Edison screw base 39. Consequently, in one embodiment the inner cavity formed by sealed plastic diffuser 36, inner tube 32 and Edison screw base 39 can withstand 1.3 bar of water pressure (3 meters of water) without allowing water to leak into the inner cavity.

The top rim 42 of outer tube 33 is also attached to the bottom surface of tube top 34, for example by brazing. Convection current guide 35 is disposed between inner tube 32 and outer tube 33. There are window openings 43 around top rim 42 of outer tube 33 that resemble openings along a castle parapet, as shown in FIG. 6D. Heated air rising between inner tube 32 and outer tube 33 escapes through the window openings 43. Alternately, when LED light bulb 30 is used with sealed plastic diffuser 36 facing downward, e.g., with Edison screw based 39 screwed into a ceiling socket, ambient air enters through the window openings 43 and exits through a circular opening 44 between inner tube 32 and outer tube 33.

When LED light bulb 30 is used in the orientation of FIG. 4, ambient air enters spiral-path chimney-effect heat sink 31 through circular opening 44. The air is heated as it comes into proximity of heated inner tube 32. Heat generated by LED 37 is conducted through aluminum platform 38 to tube top 34 and then through top rim 40 of inner tube 32 down into the cylindrical surfaces of inner tube 32 and outer tube 33. More heat is transferred from LED 37 to inner tube 32 than to outer tube 33 because only part of top rim 42 of outer tube 33 contacts tube top 34 due to the window openings 43 and because LED 37 is closer to inner tube 37 than to outer tube 33. Nevertheless, outer tube 33 is also thermally coupled to tube top 34. The heated air begins to rise in the area between inner tube 32 and outer tube 33. The distance between inner tube 32 and outer tube 33 is sufficiently small so as to create a chimney effect in which rising air pulls up air below by creating a convection current. The rising air is prevented, however, from rising vertically along the outer surface 45 of inner tube 32 by convection current guide 35. Convection current guide 35 guides the rising air in a spiral path 46 around inner tube 32. In the embodiment of FIG. 4, guide 35 makes two complete turns around inner tube 32. After reaching the end of guide 35, the rising air is allowed to rise vertically and escape through window openings 43. By traveling around the circumference of inner tube 32 at least two times, the rising air travels more than four times the distance that the air would have traveled vertically to the window openings 43 in the absence of guide 35. By increasing the length of the path 46 over which the heated air rises, the air is allowed to absorb more heat from outer surface 45 of inner tube 32. Consequently, spiral-path chimney-effect heat sink 31 transfers heat away from LED 37 more efficiently than a heat sink with inner tube 32 and outer tube 33 but without convection current guide 35.

Thus, convection current guide 35 is longer than the length 47 of outer surface 45 of inner tube 32. In the embodiment of FIG. 4, the vertical length 47 of outer surface 45 of inner tube 32 is about forty millimeters, excluding the length along the small horizontal lip of top rim 40. The thickness of the walls of each of inner tube 32 and outer tube 33 is about two millimeters. The outer diameter of inner tube 32 at circular opening 44 is about twenty-seven millimeters, and the inner diameter of outer tube 33 at circular opening 44 is about thirty-nine millimeters. Consequently, circular opening 44 is about six millimeters wide. The outer diameter of inner tube 32 at below top rim 40 is about thirty-seven millimeters, and the inner diameter of outer tube 33 below top rim 42 is about forty-nine millimeters. In the embodiment of FIG. 4, convection current guide 35 is a spiral wire with a diameter of about six millimeters. Thus, convection current guide 35 forms a complete vertical barrier between inner tube 32 and outer tube 33 that prevents air from passing between the guide and the tubes and vertically up outer surface 45 of inner tube 32.

The ability of heat sink 31 to transfer heat away from LED 37 can be improved by adjusting the width of the opening between inner tube 32 and outer tube 33 and the length of convection current guide 35. If the width of the opening between the tubes (and the diameter of guide 35) is too small, the smaller volume of air passing over outer surface 45 of inner tube 32 will carry less heat away from inner tube 32. If the width of the opening is too large, the chimney effect will be reduced as there is less convection near a cooler distant outer tube 33.

If convection current guide 35 is too short, the distance of path 46 over which the rising air travels will not be sufficiently long to allow the air to absorb significantly more heat from outer surface 45 of inner tube 32. If guide 35 makes less than one complete turn between the tubes, some heated air will rise vertically from circular opening 44 to the window openings 43. Although multiple short guides could be used to prevent any air from rising vertically, for example, by using two guides with each having half a turn, the length of the path 46 over which the heated air rises would not be long enough to allow the air to absorb significantly more heat from outer surface 45 of inner tube 32.

If convection current guide 35 is too long and forms too many spiral turns, rising air will travel too slowly, and the larger amount of heat absorbed by the air that travels over the longer path 46 will not be removed fast enough from heat sink 31 through window openings 43. Thus, the dimensions of spiral-path chimney-effect heat sink 31 are empirically determined so as to balance the increased length of the path over which the rising air passes against the slowing of the speed of the heated air as the path becomes more horizontal around the circumference of inner tube 32.

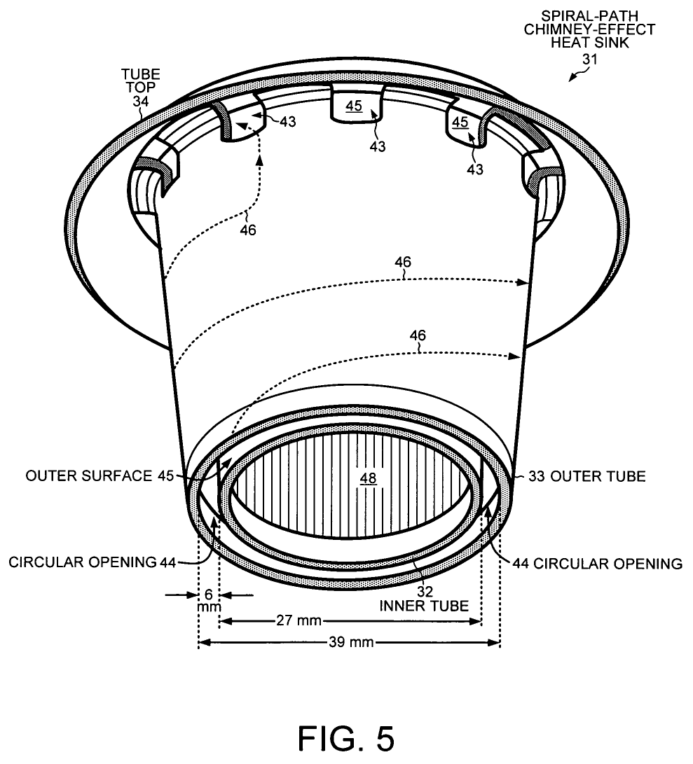

FIG. 5 is a more detailed bottom perspective view of spiral-path chimney-effect heat sink 31 of FIG. 4. FIG. 5 illustrates how air that enters heat sink 31 through circular opening 44 and is heated by inner tube 32 travels in a spiral path between the tubes and exits heat sink 31 through the window openings 43. FIG. 5 also shows that the inside surface of inner tube 32 is coated with a dielectric liner 48 that insulated outer surface 45 of inner tube 32 from the electrical components that are housed within inner tube 32. For example, an AC-to-DC driver that converts wall current to the current that powers LED 37 is contained inside inner tube 32. The inner diameter of inner tube 32 must be large enough to accommodate the AC-to-DC driver. Dielectric liner 48 isolates the AC-to-DC driver from the hand of a consumer holding heat sink 31.

FIGS. 6A-6D are perspective views showing the individual components of heat sink 31. FIG. 6A shows the wires 49 that pass from the AC-to-DC driver through holes 50 in tube top 34 in order to supply LED 37 with current. In this embodiment, wires 49 connect to conductors in aluminum platform 38 as opposed to directly to LED 37. The conductors in aluminum platform 38 are then coupled to LED 37. FIG. 6A also shows the lip around the top of tube top 34 at which airtight seal 41 is made with sealed plastic diffuser 36. FIG. 6B shows an embodiment of convection current guide 35 that resembled a spring with a circular cross section. Other embodiments of guide 35 have other cross sections, such as star-shaped, oval, triangular and rectangular. In the embodiment of FIG. 6B, guide 35 is a metal wire. In other embodiments, guide 35 is made of heat-resistant plastic. FIG. 6C shows top rim 40 of inner tube 32 that makes an airtight seal with the bottom surface of tube top 34. Top rim 40 is a circular lip around the top end of inner tube 32. Dielectric liner 48 on the inside surface of inner tube 32 is also shown. FIG. 6D shows window openings 43 around top rim 42 of outer tube 33.

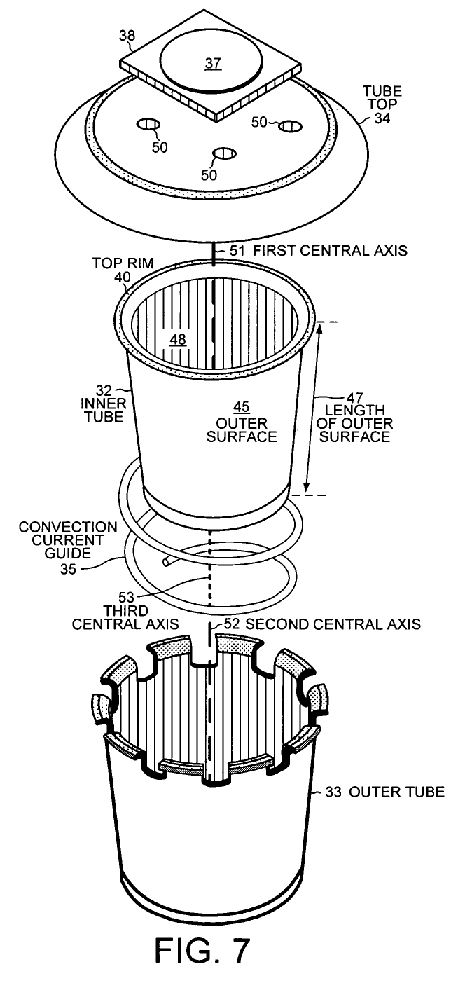

FIG. 7 is an exploded view of spiral-path chimney-effect heat sink 31 with LED 37 mounted on top of tube top 34. FIG. 7 shows that inner tube 32 has a first central axis 51, outer tube 33 has a second central axis 52, and convection current guide 35 has a third central axis 53. In the assembled heat sink of FIG. 4 (as well as in the exploded configuration) all of first central axis 52, second central axis 52 and the third central axis 53 are collinear.

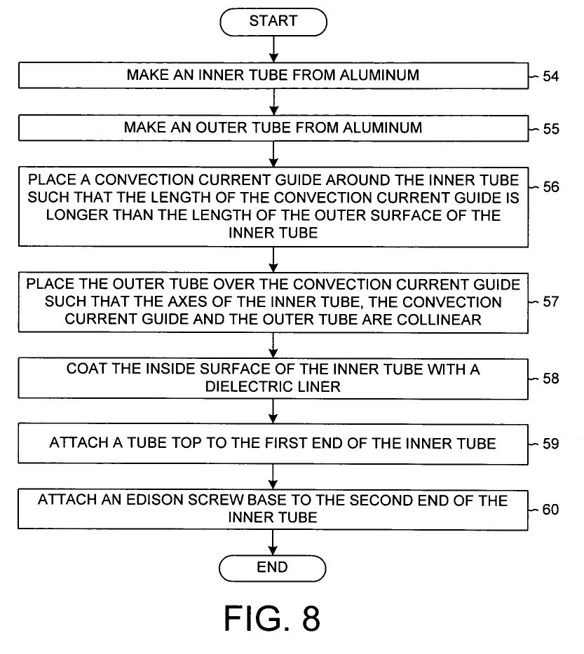

FIG. 8 is a flowchart illustrating steps 54-60 of a method of manufacturing spiral-path chimney-effect heat sink 31. In first steps 54-55, inner tube 32 and outer tube 33 are made of stamped aluminum. In step 56, convection current guide 35 is placed around inner tube 32 such that the length of guide 35 is longer than the length of outer surface 45 of inner tube 32. In one embodiment, guide 35 is a spiral wire that is formed to have the conical counter of the conical cylinder of inner tube 32. The spiral wire is dropped over inner tube 32 that is in an orientation upside down from that of FIG. 4. In step 57, outer tube 33 is placed over convection current guide 35 such that the axes 51-53 are collinear. Outer tube 32 is pressed down over guide 35 on inner tube 32 such that guide 35 forms a complete barrier between inner tube 32 and outer tube 33 that prevents air from passing between the guide and the surfaces of the tubes. In step 58, the inside surface of inner tube 32 is coated with dielectric liner 48. In step 59, tube top 34 is attached to top rim 40, which forms the first end of inner tube 32. In one embodiment, top rim 40 is attached to the bottom surface of tube top 34 by brazing.

LED light bulb 30 is then manufactured using heat sink 31 by adding aluminum platform 38, LED 37, plastic diffuser 36, a printed circuit board with the AC-to-DC driver and other internal components, and Edison screw base. In step 60, the internal components are attached to Edison screw base 39, and then Edison screw base 39 is attached to the second end of inner tube 32. Aluminum platform 38 with attached LED 37 is then glued to the top surface of tube top 34. Wires 49 from the internal components pass through the holes 50 and are attached to conductors in platform 38. Then diffuser 36 is attached to tube top 34 forming airtight seal 41.

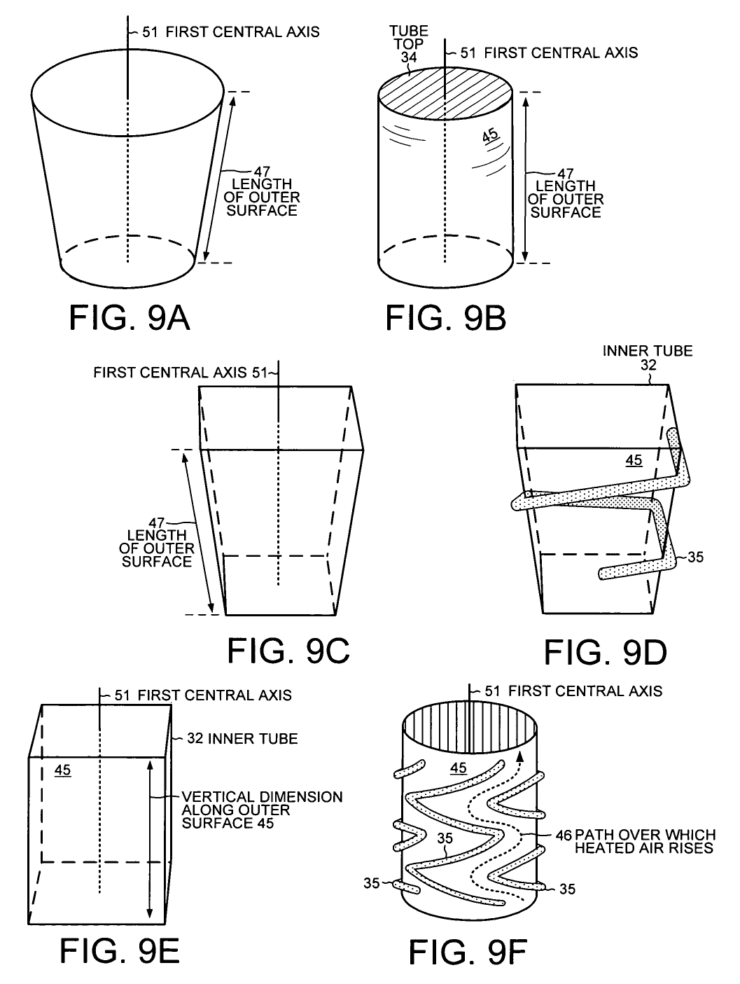

FIGS. 9A-9F are perspective views of various embodiments of inner tube 32 and outer tube 33. FIG. 9A shows the conical tube configuration of inner tube 32 of FIG. 4. FIG. 9B shows an alternative configuration in which inner tube 32 is a regular cylinder in which the vertical dimension of outer surface 45 of inner tube 32 is parallel to first central axis 51. In addition, tube top 34 and inner tube 32 are integrally formed as one piece in the embodiment of FIG. 9B. By stamping inner tube 32 and tube top 34 out of aluminum as one piece, the step 59 of attaching the tube top to top rim 40 is avoided, and manufacturing costs are saved. FIG. 9C shows another configuration in which the inner and outer tubes are square, pyramidal tubes. FIG. 9D shows how a spiral convection current guide 35 wraps around outer surface 45 of an inner tube 32 that is configured as a square, pyramidal tube. In the embodiment of FIG. 9D, guide 35 makes 1¼ turns around inner tube 32. FIG. 9E shows a configuration in which the inner and outer tubes are regular square tubes in which the vertical dimension of outer surface 45 is parallel to first central axis 51. FIG. 9F shows how a convection current guide 35 that travels in a zigzag path wraps around outer surface 45 of an inner tube 32 that is configured as a cylinder. Three separate guides 35 are attached to outer surface 45. In the embodiment of FIG. 9F, guide 35 is made of plastic that is extruded onto surface 45 of a long aluminum tube as the tube moves along axis 51 and is rotated back and forth for each zigzag. Sections of the long aluminum tube are then cut forming individual pieces of inner tube 32.

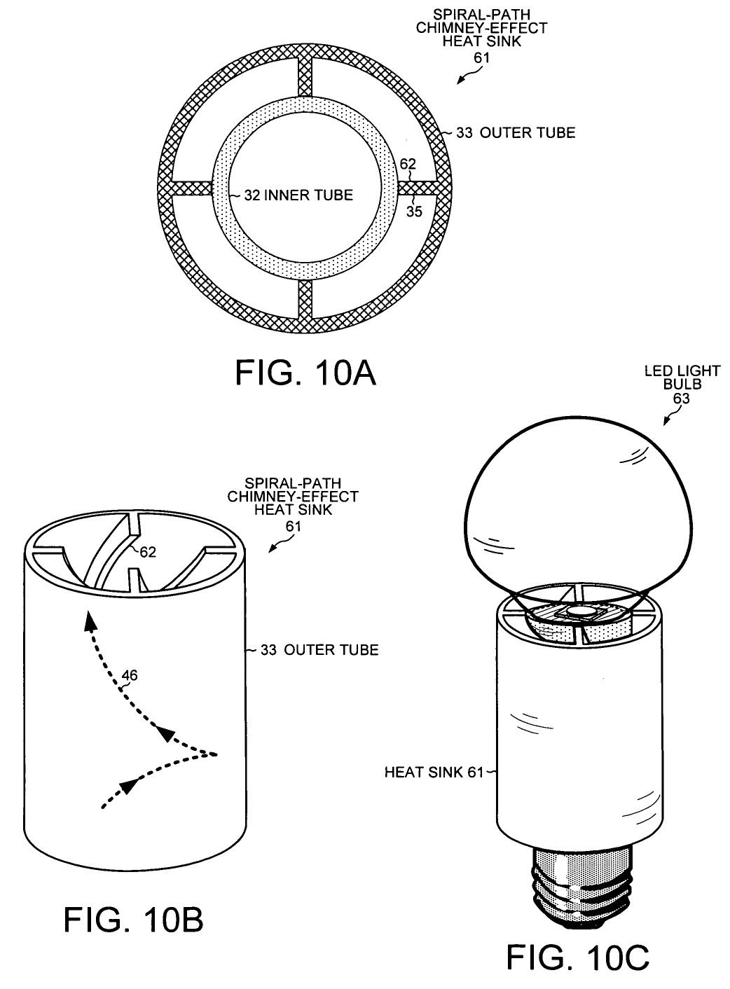

FIGS. 10A-10C show another embodiment of a spiral-path chimney-effect heat sink 61 in which convection current guide 35 is an integral part of outer tube 33. Inner tube 32 is an aluminum cup in the form shown in FIG. 9B. An extrusion process is used to form outer tube 33 having an outer aluminum wall and spiral fins 62 protruding towards the inside of the tube. The spiral fins 62 serve as convection current guide 35. In the manufacturing process of outer tube 33 as the aluminum or aluminum alloy is being drawn through the die opening, the resulting tube and fins are rotated about the central axis of the tube. Sections of the resulting long aluminum tube with inner spiral fins are then cut to form individual pieces of inner tube 32. FIG. 10A shows a cross section of the embodiment with spiral fins 62 after inner tube 32 with a cupped end is inserted into the core formed by the spiral fins. FIG. 10B is a perspective view of outer tube 33 of heat sink 61 before the aluminum cup has been inserted. The manufacturing of heat sink 61 is less involved because heat sink 61 is made from just two pieces. FIG. 10C shows an LED light bulb 63 made using spiral-path chimney-effect heat sink 61.

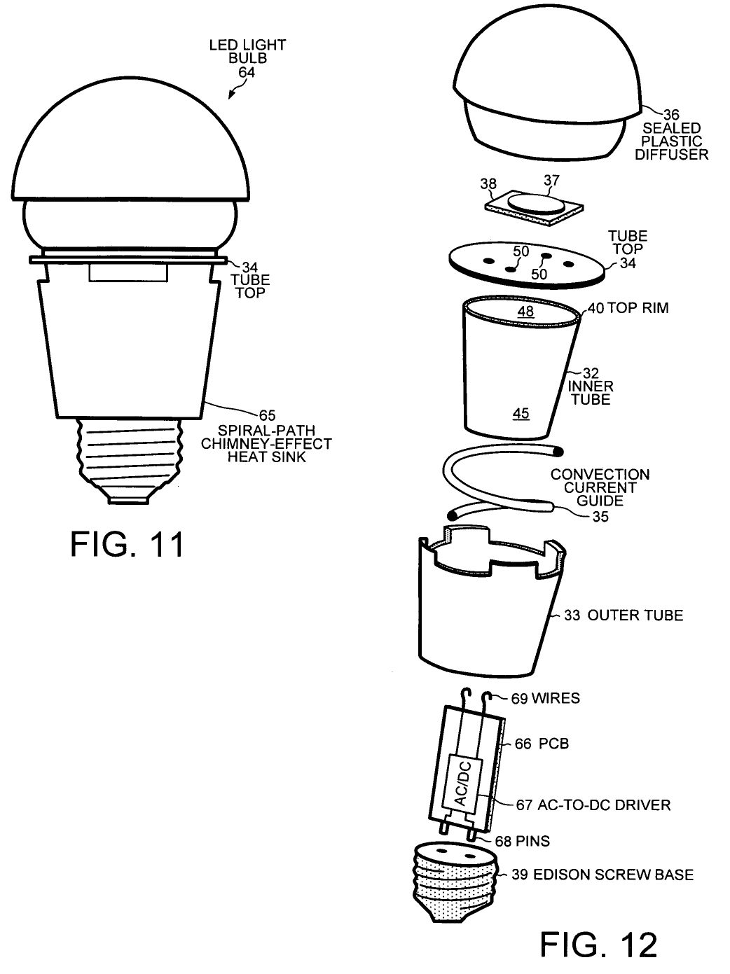

FIG. 11 shows an LED light bulb 64 made using yet another embodiment of a spiral-path chimney-effect heat sink 65. Heat sink 65 has a simpler design than heat sink 31 in that tube top 34 is a planar disk and does not have the plate shape of tube top 34 of the embodiment of FIG. 4. In addition, there is no small horizontal lip on either top rim 40 of inner tube 32 or on top rim 42 of outer tube 33.

FIG. 12 is an exploded view of LED light bulb 64 of FIG. 11. FIG. 12 shows a printed circuit board 66 on which an AC-to-DC driver 67 and other internal components are mounted. PCB 66 has pins 68 that insert into holes in Edison screw base 39 and receive the wall current. Wires 69 from AC-to-DC driver 67 pass through the holes 50 in tube top 34 and are attached to conductors in platform 38.

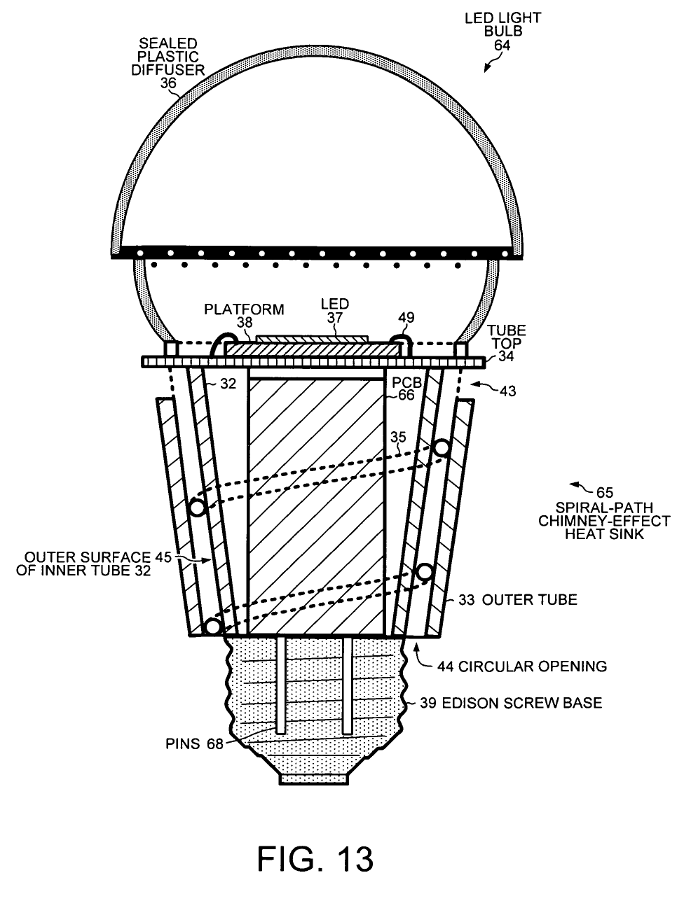

FIG. 13 is a cross sectional view of LED light bulb 64 with spiral-path chimney-effect heat sink 65.

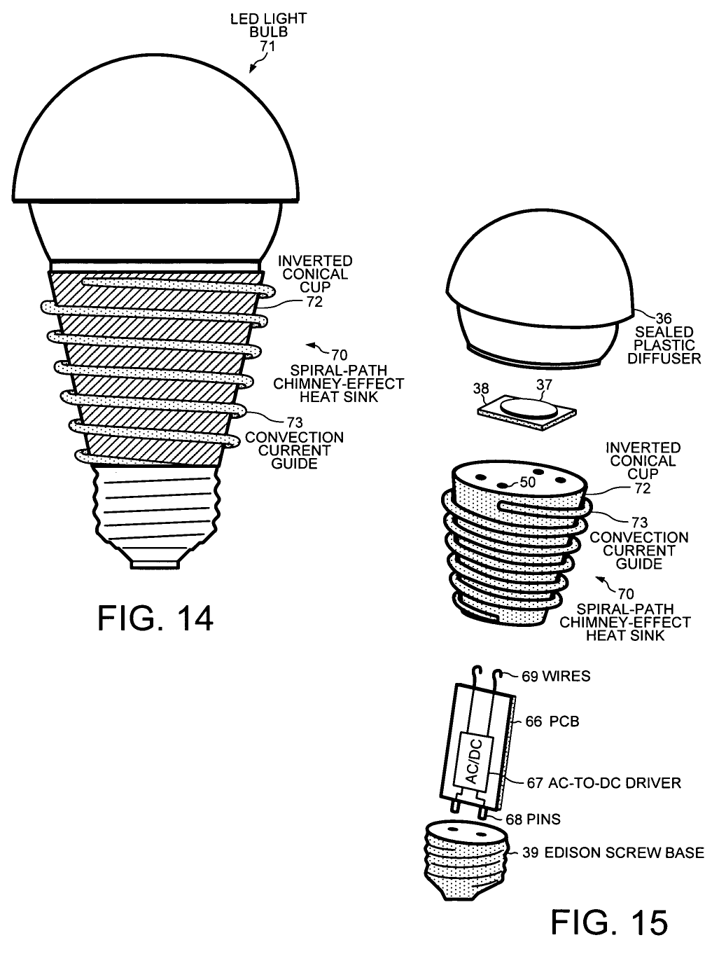

FIG. 14 shows yet another embodiment of a spiral-path chimney-effect heat sink 70 used in an LED light bulb 71. Heat sink 70 has an even simpler design than heat sink 65 because heat sink 70 is a single piece. Heat sink 70 is an inverted conical cup 72 with integrally formed spiral fins in the form of a convection current guide 73. The spiral fins force rising air that is heated by the outer surface of conical cup 72 to follow the contour of the outer surface of conical cup 72. Rising air flows along the channel formed under the fins of convection current guide 73.

FIG. 15 is an exploded view of LED light bulb 71 of FIG. 14. FIG. 12 shows that printed circuit board 66 and AC-to-DC driver 67 fit up inside the bottom opening of inverted conical cup 72. Wires 69 from AC-to-DC driver 67 pass through holes 50 in the “bottom” of inverted conical cup 72.

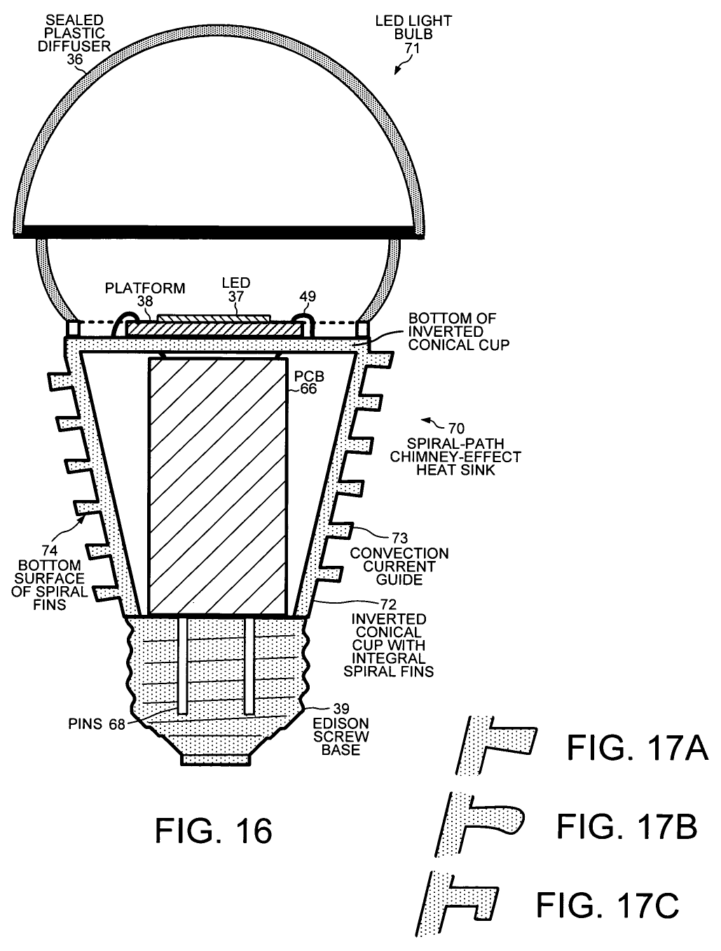

FIG. 16 is a cross sectional view of LED light bulb 71 with spiral-path chimney-effect heat sink 70. FIG. 16 shows that the bottom surface 74 of the spiral fins of convection current guide 73 is slanted slightly downward and away from the outer surface of inverted conical cup 72. The downward slant keeps the rising heated air in a path around conical cup 72 and enables the chimney effect.

FIGS. 17A-17C show enlarged cross sections of the spiral fins of various embodiments of spiral-path chimney-effect heat sink 70. FIG. 17A shows the fins of convection current guide 73 of FIG. 16. FIG. 17B shows a rounded bump end of a spiral fin that can be formed by subjecting planar spiral fins to an extreme heat source in a ring around conical cup 72. Under the extreme heat, the planar fins begin to melt and sag. A channel is formed under the sagging fins that guides the heated rising air in a spiral around the outer surface of inverted conical cup 72. FIG. 17C shows a spiral fin with a downward facing lip that also forms a channel that guides the rising heated air and provides a chimney effect.

Although certain specific embodiments are described above for instructional purposes, the teachings of this patent document have general applicability and are not limited to the specific embodiments described above. The heat sinks of FIGS. 4 and 11 are used to cool LED lights. However, these heat sinks can also be used to cool other sources of heat, such as electronic components. Accordingly, various modifications, adaptations, and combinations of various features of the described embodiments can be practiced without departing from the scope of the invention as set forth in the claims.

What is claimed is:

1. An apparatus, comprising:
an outer tube;
an inner tube disposed in the outer tube such that the inner tube and the outer tube are coaxial;
a tube top disposed at an end of the inner tube, wherein the tube top is thermally coupled to the inner tube; and
a convection current path guide disposed between the inner tube and the outer tube.

2. The apparatus of claim 1, wherein the apparatus is a chimney-effect heat sink.

3. The apparatus of claim 1, wherein the convection current path guide is a spiral structure.

4. The apparatus of claim 1, wherein the convection current path guide causes a convection current to follow a spiral path.

5. The apparatus of claim 1, wherein the tube top includes an amount of sheet material in a shape of a disk, wherein the disk substantially covers the end of the inner tube, wherein the amount of sheet material in the shape of the disk extends in a plane, and wherein the plane is perpendicular to a central axis of the inner tube.

6. The apparatus of claim 1, wherein the end of the inner tube defines a circular lip, wherein the circular lip is disposed in a plane, and wherein the tube top contacts the circular lip.

7. The apparatus of claim 1, wherein the tube top and the inner tube are integrally formed such that the end of the inner tube is capped.

8. The apparatus of claim 1, wherein the tube top and the inner tube are integrally formed.

9. A device comprising:
an inner tube with a first central axis;
a tube top disposed at an end of the inner tube, wherein the tube top is thermally coupled to the inner tube;
an outer tube with a second central axis; and
a convection current guide with a third central axis, wherein all of the first central axis, the second central axis and the third central axis are collinear, wherein the convection current guide is disposed between the inner tube and the outer tube.

10. The device of claim 9, wherein the inner tube has an outer surface with a length aligned with the first central axis, and wherein the convection current guide is longer than the length of the outer surface of the inner tube.

11. The device of claim 9, further comprising:
a heat source, wherein the heat source is attached to the tube top.

12. The device of claim 9, wherein the inner tube has a shape taken from the group consisting of: a cylindrical tube, a square tube and a conical tube.

13. The device of claim 9, wherein the inner tube and the tube top are integrally formed.

14. The device of claim 9, wherein the convection current guide is a spiral wire.

15. The device of claim 9, wherein the tube top is disposed at an end of the outer tube, and wherein window openings are disposed at the end of the outer tube adjacent to the tube top.

16. A device comprising:
an inner tube with a first central axis;
an outer tube with a second central axis;
a convection current guide with a third central axis, wherein all of the first central axis, the second central axis and the third central axis are collinear, and wherein the convection current guide is disposed between the inner tube and the outer tube; and
a light emitting diode (LED) that is thermally coupled to the inner tube.

17. The device of claim 16, further comprising:
an Edison screw base attached to the inner tube.

18. The device of claim 16, further comprising:
a tube top thermally coupled to the inner tube.

19. A method of manufacturing a chimney-effect heat sink, comprising:
placing a convection current guide around an inner tube having a first central axis;
placing an outer tube having a second central axis over the convection current guide, wherein the first central axis and the second central axis are collinear; and
attaching a tube top to a first end of the inner tube, wherein the inner tube has an outer surface with a length in the direction of the first central axis, and wherein the convection current guide is longer than the length of the outer surface of the inner tube.

20. The method of claim 19, wherein the inner tube has an inner surface, further comprising:
coating the inside surface of the inner tube with a dielectric liner.

21. The method of claim 19, further comprising:
attaching an Edison screw base to a second end of the inner tube.

22. The method of claim 19, wherein the convection current guide is a spiral wire.

23. A device comprising:
an inner tube;
a tube top disposed at an end of the inner tube, wherein the tube top is adapted to be coupled to a heat source;
an outer tube, wherein the inner tube is disposed inside the outer tube, wherein heated air rises along a path between the inner tube and the outer tube, and wherein the path over which the heated air rises has a length; and
means for increasing the length of the path over which the heated air rises.

24. The device of claim 23, wherein the means has a spiral form.

25. The device of claim 23, wherein the heat source is a light emitting diode.

26. The device of claim 23, wherein the inner tube has a shape taken from the group consisting of: a cylindrical tube, a square tube and a conical tube.

27. A chimney-effect heat sink comprising:
an outer tubular portion;
an inner tubular portion disposed inside the outer tubular portion such that the inner and outer tubular portions are coaxial, wherein the inner tubular portion has an outer surface with a length parallel to a coaxial dimension; and
a guide disposed between the inner tubular portion and the outer tubular portion that forms a convection current path between the inner tubular portion and the outer tubular portion, wherein the convection current path is longer than the length of the outer surface of the inner tubular portion.
